(19) United States
(12) Patent Application Publication
(10) Pub. No.: US 2012/0159843 A1
(43) Pub. Date: Jun. 28, 2012

(54) WATER RETENTION DEVICE FOR AN INDIVIDUAL PLANT CONTAINER

(75) Inventor: Carl E. Whitcomb, Stillwater, OK (US)

(73) Assignee: LACEBARK, INC., Stillwater, OK (US)

(21) Appl. No.: 13/411,715

(22) Filed: Mar. 5, 2012

Related U.S. Application Data
(63) Continuation-in-part of application No. 12/835,828, filed on Jul. 14, 2010.

(51) Int. Cl. A01G 9/02; A01G 13/02; B23P 19/04

(52) U.S. Cl. 47/21.1; 29/428; 47/20.1; 47/31.1

(57) ABSTRACT

A water retention device is used in conjunction with a plant container. The water retention device comprises a resilient plate structure forming a central cover, a sidewall extending from a perimeter of the central cover, and a slot extending through the sidewall and a portion of the central cover. The sidewall engages an inner surface of the plant container and supports the central cover at a spaced distance above a growth medium. The resilient plate structure is manually configurable to open the slot for receiving a plant stem so that the plant stem extends through the central cover. Water may be supplied to the plant container using either a spray stake disposed under the central cover or using a trough formed in the central cover. Where a spray stake is used, the inner surfaces of the sidewall and central cover may include ribs that deflect water.

### CROSS-REFERENCE TO RELATED APPLICATIONS

This application is a continuation-in-part of, and claims priority to, co-pending U.S. patent application Ser. No. 12/835,828, filed on Jul. 14, 2010.

### BACKGROUND

1. Field of the Invention

The present invention relates generally to devices for watering a plant, and more particularly to devices for watering a plant growing in an individual container.

2. Background of the Related Art

Plant nurseries produce large numbers of plants, typically in temporary containers that allow the plants to grow to a size suitable for planting into a landscape. As with any plant, these plants must receive an appropriate amount of water. Depending upon the size of the nursery and perhaps the range of plant varieties and conditions, these individually containerized plants may be watered by hand using a hose and spray nozzle, by an overhead or area sprinkler system, or by individual spray nozzles (spray stakes) positioned at each of the plants. Watering by hand can be very labor intensive and the use of large area sprinkler systems can lead to significant water losses since much of the water does not end up in the containers.

Many nurseries now deliver water to their containerized plants on a container-by-container basis to conserve water, either to reduce their expenditures on water or to meet local water conservation regulations. Spray stakes are designed for an irrigation system of this type. A spray stake has a sharp stake end that is pushed into the plant growth medium within the container in order to position a spray structure above the top surface of the medium. The spray structure is coupled to a small water supply tube. As water is delivered through the tube, the spray structure releases the water in a spray pattern that distributes water across the top surface of the medium within the container. However, the spray stakes are often imprecisely positioned and may easily tilt out of its ideal angle as a result of something bumping the container or tugging on the water supply tube. When the stake tilts, the spray structure is no longer accurately directed over the top of the medium and may spray water outside the container. Likewise, an improperly angled spray structure may fail to deliver water to one or more portions of the growth medium. As a result of receiving no water in these portions, no roots will grow in that area and plant growth will be restricted. Accordingly, a spray stake may not reliably conserve water as intended. Furthermore, even a properly oriented spray stake produces a spray pattern that is subject to wind distorting the spray pattern, such that part of the water misses the container entirely. Wind also increases the evaporative loss of water before it reaches the surface. Accordingly, wind conditions may cause a significant loss of water.

### BRIEF SUMMARY

One embodiment of the present invention provides a water retention device for use with a plant container. The water retention device comprises a resilient plate structure forming a central cover, a sidewall extending from a perimeter of the central cover, and a slot extending through the sidewall and a portion of the central cover. The sidewall engages an inner surface of the plant container and supports the central cover at a sufficient distance above a growth medium in the plant container to accommodate use of a spray nozzle under the central cover. The resilient plate structure is manually configurable to open the slot for receiving a plant stem so that the plant stem extends through the central cover.

Another embodiment of the present invention provides a system for growing a plant. The system includes a plant container including an inner surface having an inside diameter, wherein the inner surface extends above a growth medium within the plant container. The system further includes a resilient plate structure forming a central cover, a sidewall extending from a perimeter of the central cover, and a slot extending through the sidewall and a portion of the central cover, wherein the sidewall engages the inner surface of the plant container and supports the central cover at a spaced distance above the growth medium, and wherein the resilient plate structure is manually configurable to open the slot for receiving a plant stem so that the plant stem extends through the central cover. Still further, the system includes a spray nozzle disposed between the central cover and the growth medium within the plant container, wherein the spray nozzle is coupled to a water supply tube and directs water across the growth medium.

Yet another embodiment of the invention provides a method of installing a water retention cover about a stem of a plant within a plant container. The method comprises: manually opening a slot formed in a sidewall and central cover of a resilient plate structure; positioning the resilient plate structure so that the stem of the plant is received within the opened slot; manually over-closing the slot to temporarily reduce the effective diameter of the resilient plate structure to less than the diameter of an inside surface of the plant container; lowering the resilient plate structure inside the plant container; and allowing the resilient plate structure to expand outwardly into engagement with the inside surface of the plant container.

### BRIEF DESCRIPTION OF THE SEVERAL VIEWS OF THE DRAWINGS

FIG. 1 is a perspective view of a water retention device according to one embodiment of the present invention.

FIG. 2 is a perspective view of the water retention device with a slot in an open position for placement about a plant stem.

FIG. 3 is a perspective view of the water retention device being positioned above of plant container with a plant stem and watering tube received within the open slot of the water retention device.

FIG. 4 is a partial cross-section, perspective view of the water retention device in a reduced-diameter condition allowing the water retention device to be received within the upper lip of the plant container.

FIG. 5 is a perspective view of the water retention device in a fully installed position within the plant container.

FIG. 6 is a cross-sectional side view of the water retention device illustrating water retention and distribution, including deflection of water off the ribs formed on the underneath surface of the water retention device.

FIG. 6A is a cross-sectional side view of a portion of the water retention device of FIG. 6 with the rim interacting with a special feature on the inner surface of the plant container.

FIG. 7 is a bottom view of the water retention device illustrating water retention and distribution, including deflection of water off the undulation side walls.

FIG. 8 is a perspective view of an alternative embodiment of a water retention device having a side wall with bendable segments that allow the device to fit within containers of various diameters.

FIGS. 9A-9E are schematic bottom views of various embodiments of a water retention device.

FIG. 10 is a perspective view of a second embodiment of the water retention device in a fully installed position within the plant container.

FIG. 11 is a cross-sectional side view of the water retention device of FIG. 10 illustrating water distribution through a trough.

FIG. 12 is a cross-sectional view of the trough in the water retention device of FIG. 11.

### DETAILED DESCRIPTION

One embodiment of the present invention provides a water retention device for use with a plant container. The water retention device comprises a resilient plate structure forming a central cover, a sidewall extending from a perimeter of the central cover, and a slot extending through the sidewall and a portion of the central cover. The sidewall engages an inner surface of the plant container and supports the central cover at a sufficient distance above a growth medium in the plant container to accommodate use of a spray nozzle under the central cover. The resilient plate structure is manually configurable to open the slot for receiving a plant stem so that the plant stem extends through the central cover.

Various embodiments of the water retention device serve one or more beneficial purposes. One such purpose is preventing water streams from being sprayed out of the plant container. Such overspray can occur due to a misaligned or tilted spray nozzle. Another purpose is preventing properly-directed water streams from being driven out of the container by wind. Yet another purpose is to implement an improvement to the distribution of water across the surface of the growth medium within the plant container. A still further purpose is to reduce water evaporation from the growth medium. The water retention device may also serve the purpose of preventing weed growth within the growth medium. Each of these purposes increases the efficiency of water utilization.

The resilient plate structure preferably has ribs on its inner surfaces that are exposed to water streams from the spray nozzle. For example, the sidewall of the resilient plate structure preferably has an inner surface forming a plurality of ribs. Water streams that are directed against these sidewalls will deflect or splatter in one or more directions to improve the overall distribution of water over the surface of the growth medium. In one embodiment, the plurality of ribs on the inner surface of the sidewall forms a continuous undulating surface. Although the ribs of the sidewall may be formed in many shapes, sizes, spacing and positions, the ribs preferably have inner peaks that extend inwardly from outer peaks by a distance of from 5 to 20 percent of the diameter of the resilient plate structure. Similarly, the central cover of the resilient plate structure preferably has an inner surface forming a plurality of ribs. Water streams that are directed against the central cover will be deflected or splatter in one or more directions to improve the overall distribution of water over the surface of the growth medium. The ribs of the central cover may be formed in many shapes, sizes, spacings and positions, and may be the same as or different from the ribs of the sidewall. In one embodiment, the plurality of ribs extends in a pattern forming concentric rings around a generally central axis of the resilient plate structure.

Optionally, the sidewall may include an outwardly-extending rim. The rim preferably extends from a distal edge of the sidewall. For example, if an upper edge of the sidewall is coupled to the central cover, then the rim may extend outwardly from the lower edge of the sidewall. At least a portion of the rim should engage an inner surface of the plant container in order to prevent the resilient plate structure from being displaced. A continuous or discontinuous rim may service this purpose. However, a continuous rim, such as a rim having a generally circular perimeter, may be preferred for the purpose of reducing water evaporation and weed growth.

The slot that extends through the sidewall and a portion of the central cover is provided to enable a plant stem to be received and extend through the cover with the slot in the closed position. The resilient plate structure biases the slot toward the closed position, and a manual force must be applied to open the slot sufficiently to receive the plant stem. To reduce the amount of manual force required and to prevent damage to the central cover, the slot will preferably extend more than half way across a diameter of the resilient plate structure. The slot preferably also enables a water supply tube to extend through the cover with the slot in the closed position. The slot itself does not require any particular width, and may be alternately referred to as a slit or cut. The slot may be formed during molding of a plastic version of the resilient plate structure, or the slot may be cut in a resilient plate structure that has already been formed.

The slot extends from the sidewall across the central cover to a central opening wherein the plant stem may be received and extend through the central cover in the closed position. In one option, the central opening may be permanently open, such as a hole formed or cut into the central cover with a diameter sufficient for the plant stem. In another option, the central opening may be selectively open, such as a star-shaped series of cuts that form flaps that will fold back when the slot is closed causing the flaps to push against the plant stem.

The central cover may also include one or more holes to receive a stake to be secured in a growth medium within the plant container. For example, the stake may include a head that is larger than the hole so that the stake secures the central cover in an installed position. In one embodiment, the central cover includes a first plurality of spaced apart holes on a first side of the slot and a second plurality of spaced apart holes on a second side of the slot, wherein the first plurality of spaced apart holes are aligned with the second plurality of spaced apart holes to receive a landscape staple there through. Accordingly, the two legs of the landscape staple may straddle the slot and extend through the holes even if the opposing edges of the slot are overlapped. Having the staple straddle the slot also helps to prevent the edges of the slot from rising up and catching wind.

In a further option, the central cover may have a first notch along a first edge of the slot and second notch along a second edge of the slot, wherein the first and second notches are aligned for receiving the water supply tube there through even when the first and second edges of the slot are overlapped.

Another embodiment of the present invention provides a system for growing a plant. The system includes a plant container including an inner surface having an inside diameter, wherein the inner surface extends above a growth medium within the plant container. The system further includes a resilient plate structure forming a central cover, a sidewall extending from a perimeter of the central cover, and a slot extending through the sidewall and a portion of the central cover, wherein the sidewall engages the inner surface of the plant container and supports the central cover at a spaced distance above the growth medium, and wherein the resilient plate structure is manually configurable to open the slot for receiving a plant stem so that the plant stem extends through the central cover. Still further, the system includes a spray nozzle disposed between the central cover and the growth medium within the plant container, wherein the spray nozzle is coupled to a water supply tube and directs water across the growth medium. It should be recognized that any of the embodiments of the water retention device describe herein may be used in the system.

Yet another embodiment of the invention provides a method of installing a water retention cover about a stem of a plant within a plant container. The method comprises: manually opening a slot formed in a sidewall and central cover of a resilient plate structure; positioning the resilient plate structure so that the stem of the plant is received within the opened slot; manually over-closing the slot to temporarily reduce the effective diameter of the resilient plate structure to less than the diameter of an inside surface of the plant container; lowering the resilient plate structure inside the plant container; and allowing the resilient plate structure to expand outwardly into engagement with the inside surface of the plant container. It should be recognized that any of the embodiments of the water retention device describe herein, and perhaps other devices, may be used in performing the method.

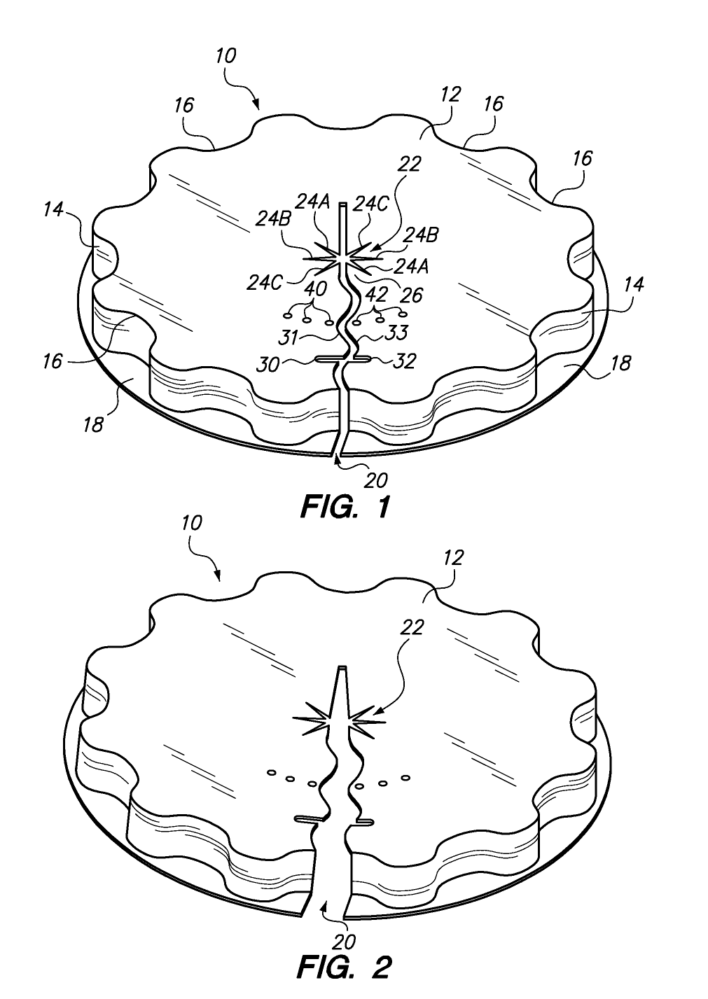

FIG. 1 is a perspective view of a water retention device according to one embodiment of the present invention. The water retention device of FIG. 1 takes the form of a resilient plate structure 10 having a central cover 12, a sidewall 14 extending from a perimeter of the central cover 12, and a slot 20 extending through the sidewall 14 and a portion of the central cover 12. The sidewall 14 supports the central cover 12 at a sufficient distance above a growth medium in the plant container to accommodate use of a spray nozzle under the central cover 12. As shown, the sidewall 14 forms a plurality of ribs 16 extending inwardly, and includes a rim 18 extending outwardly from a distal (lower) edge of the sidewall 14.

The slot 20 extends through the sidewall 14 (including the rim 16) and more than halfway across the diameter of the resilient plate structure 10. The slot 20 communicates with a central opening 22, which is shown as selectively open, for receiving a plant stem. As a result of the slot 20 and a set of three cuts 24A-C extending across the slot 20, the central opening includes a set of eight (8) flaps 26.

The central cover 12 also has a first notch 30 along a first edge 31 of the slot 20 and second notch 32 along a second edge 33 of the slot 20. The first and second notches 30, 32 are aligned for receiving the water supply tube there through even when the first and second edges 31, 33 of the slot are overlapped. Alternatively, the same objective could be achieved with just a single notch on one side of the slot. It should also be recognized that the first and second notches 31, 32, or a single one of the notches 31, 32, may be formed in the sidewall 14 where the sidewall intersects with the slot 20, either in the vertical portion or the rim 18.

Still further, the central cover 12 includes a hole 40 through the central cover 12 to receive a stake to be secured in a growth medium within a plant container. The stake preferably includes a head that is larger than the hole so that the stake secures the central cover in an installed position. More specifically, the central cover 12 includes a first plurality of spaced apart holes 40 through the central cover on a first side 31 of the slot and a second plurality of spaced apart holes 42 through the central cover on a second side 33 of the slot, wherein the first plurality of spaced apart holes are aligned with the second plurality of spaced apart holes to receive a landscape staple there through.

FIG. 2 is a perspective view of the water retention device with the slot 20 in an open position for placement about a plant stem. The slot 20 can be opened with less force, resulting in less strain on the resilient plate structure 10, since the slot extends more than halfway across the diameter of the structure 10.

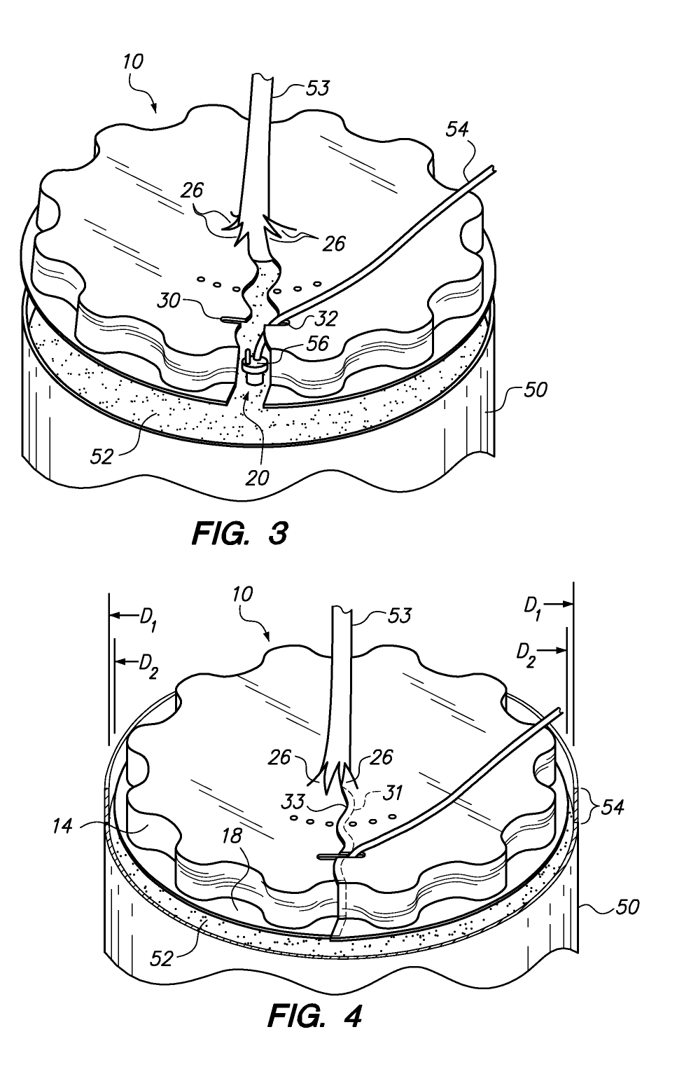

FIG. 3 is a perspective view of the water retention device being positioned above a plant container 50 with a plant stem 53 and watering tube 54 received within the open slot 20 in the resilient plate structure 10. As shown, the flaps 26 are resilient and have begun to fold back and open as a user moves the structure 10 into position around the plant stem 53. With the resilient plate structure 10 in this position, it may be desirable to position the tube 54 within, or at least in alignment with, one of the notches 30, 32. It the position of the spray nozzle 56 does not facilitate the alignment, it may be necessary to reposition the spray nozzle 56. A preferred spray nozzle 56 may be in the form of a spray stake, which can be repositioned by simply pulling the stake out of the growth medium 52 and reinserting it in the desired position.

FIG. 4 is a partial cross-sectional, perspective view of the water retention device in a reduced-diameter condition allowing the water retention device to be received within the exposed upper lip 54 of the plant container 50. This reduced-diameter condition is achieved by a user applying a manual force that causes the first and second edges 31, 33 of the slot to overlap each other. As the edges are being made to overlap, the resilient flaps 26 continue to fold back since the plant stem 53 is substantially incompressible.

Accordingly, the reduced diameter D₂ (of FIG. 4) is less than the relaxed diameter (of FIG. 1) and the expanded diameter (of FIGS. 2 and 3). Furthermore, the reduced diameter D₂ is less than the inner diameter D₁ of the exposed upper lip 54 of the plant container 50. As a result, with the resilient plate structure 10 in the reduced-diameter condition, the structure 10 may be lowered around the plant stem 53 until the sidewall 14 comes to rest on the top surface of the growth medium 52. In embodiments where the rim 18 extends from the lower edge of the sidewall 14, the rim 18 may be pressed against the growth medium. Once the resilient plate structure 10 has been lowered into the position shown in FIG. 4, the user may release the structure 10 and allow it to expand.

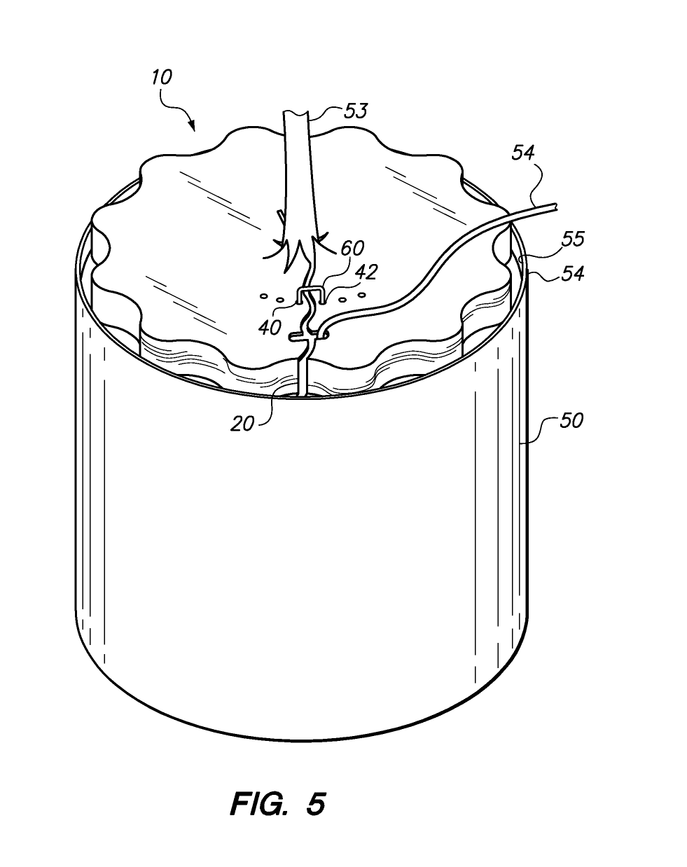

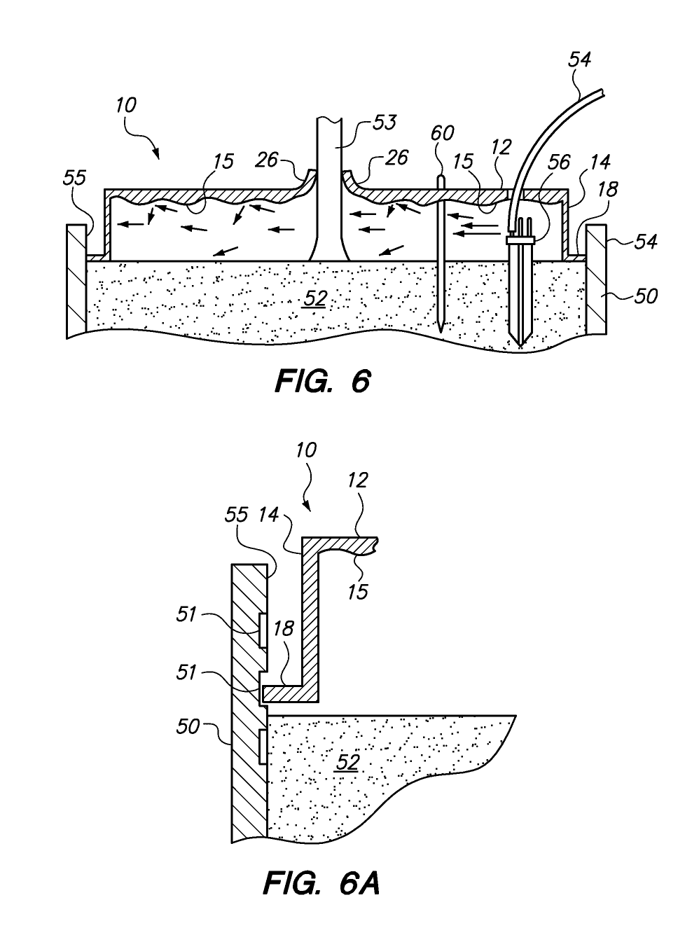

A fully installed water retention device will now be discussed in reference to both FIG. 5 and FIG. 6. FIG. 5 is a perspective view of the water retention device in a fully installed position within the plant container 50, and FIG. 6 is a cross-sectional side view of the water retention device.

In FIG. 5, the resilient plate structure 10 has expanded radially outwardly because the resilient material of the plate structure 10 will tend to move back toward its relaxed condition (see FIG. 1). An optional landscaping staple 60 has been extended through a pair of holes 40, 42 that straddle the slot 20 to further secure the structure 10 and to specifically prevent an edge of the slot from catching wind. In this fully installed position of FIG. 5, it should be appreciated that water from the spray nozzle is prevented from overshooting the sidewall of the plant container regardless of any misalignment of the spray nozzle. The full coverage over the growth medium also results in reduced evaporation from the growth medium and little light to support any weed growth.

FIG. 6 is a cross-sectional side view of the water retention device in the fully installed position as in FIG. 5. The sidewall 14 is shown supporting the central cover 12 at a sufficient distance above the growth medium 52 so that the spray nozzle 56 can send water over a substantial portion of the growth medium 52. Depending upon the angle of the nozzle 56 and the diameter of the plant container 50, some of the water may be sprayed directly onto the growth medium 52, some of the water may be deflected off the inner surface of the central cover 12, and some of the water may be deflected off the inner surface of the sidewall 14. As shown in FIG. 6, arrows are used to illustrate water streams and how the water retention device provides water retention and distribution, including deflection of water streams off a plurality of ribs 15 formed on the inner surface of the central cover 12. The water supply tube 54 provides pressurized water to the spray nozzle 56, which sends the water out across the surface of the growth medium 52. Suitable spray nozzles are disclosed in U.S. Pat. Nos. 3,595,524 and 3,638,863, which are incorporated by reference herein. If water is directed against the inner surface of the central cover 12, the water is blocked from overshooting the plant container and is deflected at one or more angles across the growth medium 52.

The rim 18 is preferably in contact with the inner surface 55 of the upper lip 54 of the plant container 50. In fact, depending upon the exact diameter of the upper lip 54 and the exact relaxed diameter of the resilient plate structure 10, the rim may be pressed up against the upper lip 54 at one or more points about the perimeter of the structure 10. Accordingly, friction between the rim 18 and the upper lip 54 will tend to secure the resilient plate structure 10 in the fully installed position shown.

FIG. 6A is a cross-sectional side view of a portion of the water retention device of FIG. 6, with the rim 18 interacting with a special feature 51 on the inner surface 55 of the plant container 50. As shown, the special feature 51 is a groove that receives the edge of the rim 18 as the rim expands to engage the inner surface 55. With the rim 18, or any portion of the rim 18, received in the special feature 51, the special feature 51 will provide resistance against upwardly displacing the rim 18, unless the rim is first retracted as in FIG. 4. Accordingly, the special feature may be used lock the resilient plate structure in place.

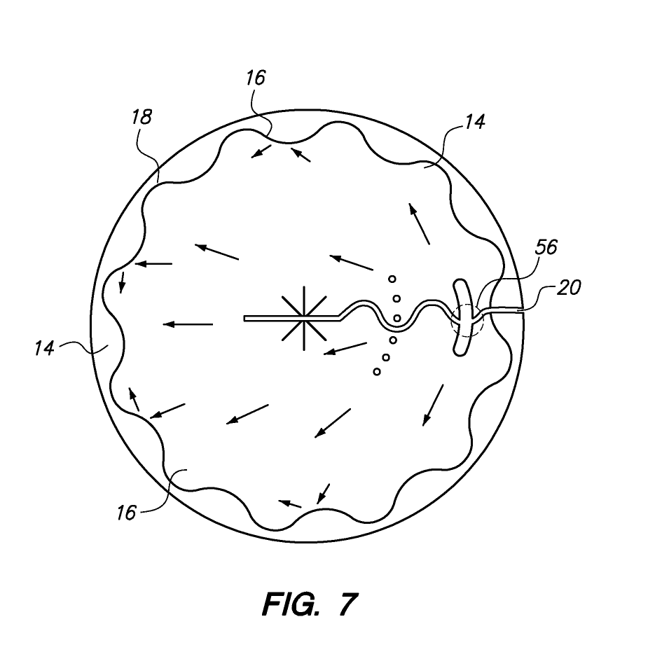

FIG. 7 is a bottom view of the water retention device illustrating water retention and distribution, including deflection of water off the undulating side walls. The location of a hypothetical spray nozzle 56 is shown in dashed lines, and the resulting water streams are represented by arrows. Water is sprayed at a wide angle over the surface of the growth medium. A water stream that reaches the sidewall 14 may be deflected in one or more directions. The ribs 16 form an undulating pattern, such that some portions of the ribs will tend to deflect a water stream in one direction and another portion of the ribs will tend to deflect a water stream in another direction. The plurality of ribs 15 formed on the inner surface of the central cover 12 (See FIG. 6) would normally be seen in this view, but have been omitted in order to more clearly illustrate the water streams.

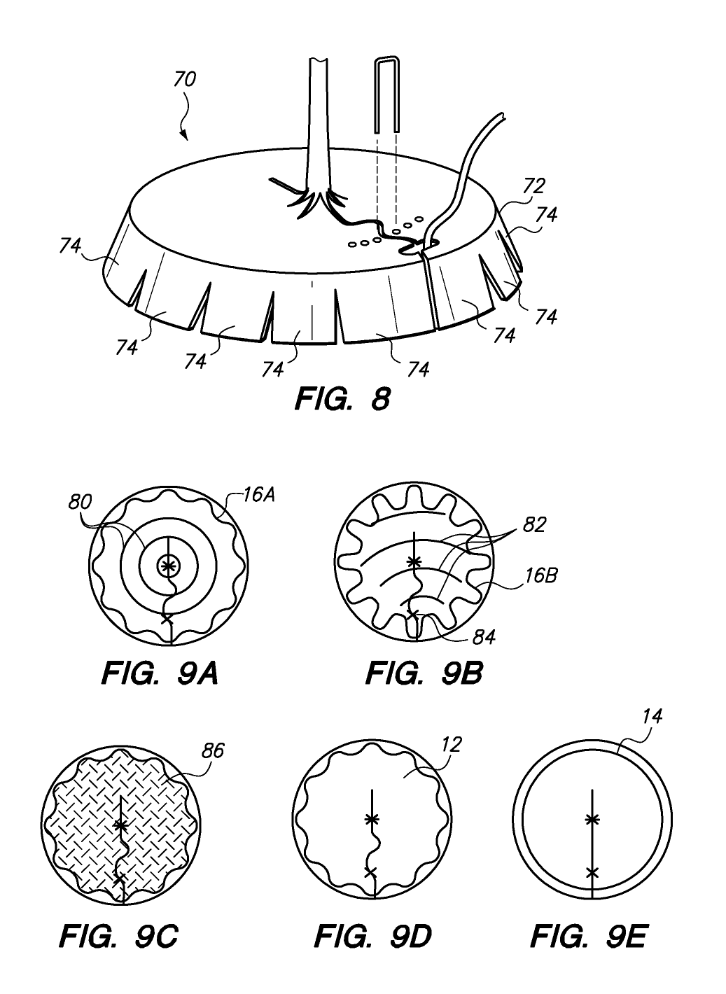

FIG. 8 is a perspective view of an alternative embodiment of a water retention device forming a resilient plate structure 70 having a side wall 72 with bendable segments 74 that allow the device to fit within containers having a range of diameters. The bendable segments 74 may be formed by V-shaped openings formed in the sidewall. This sidewall configuration may be used in combination with any of the resilient plate structure embodiments described herein.

FIGS. 9A-9E are schematic bottom views of various embodiments of a water retention device. FIG. 9A shows a resilient plate structure having concentric ribs 80 formed on the inner surface of the central cover. FIG. 9B shows a resilient plate structure having radial ribs 82 formed on the inner surface of the central cover. Here, the radial ribs are arcs having a given distance from the expected position 84 of a spray nozzle. Furthermore, the ribs 16B are much more pronounced that the ribs 16A of FIG. 9A. FIG. 9C shows a resilient plate structure having texture 86 formed on the inner surface of the central cover. FIG. 9D shows a resilient plate structure in which the inner surface of the central cover 12 does not have ribs or texture, though there are ribs shown in the sidewall. FIG. 9E shows a resilient plate structure having no ribs and no texture on the inner surface of the central cover 12 as in FIG. 9D, but also having a sidewall 14 with no ribs.

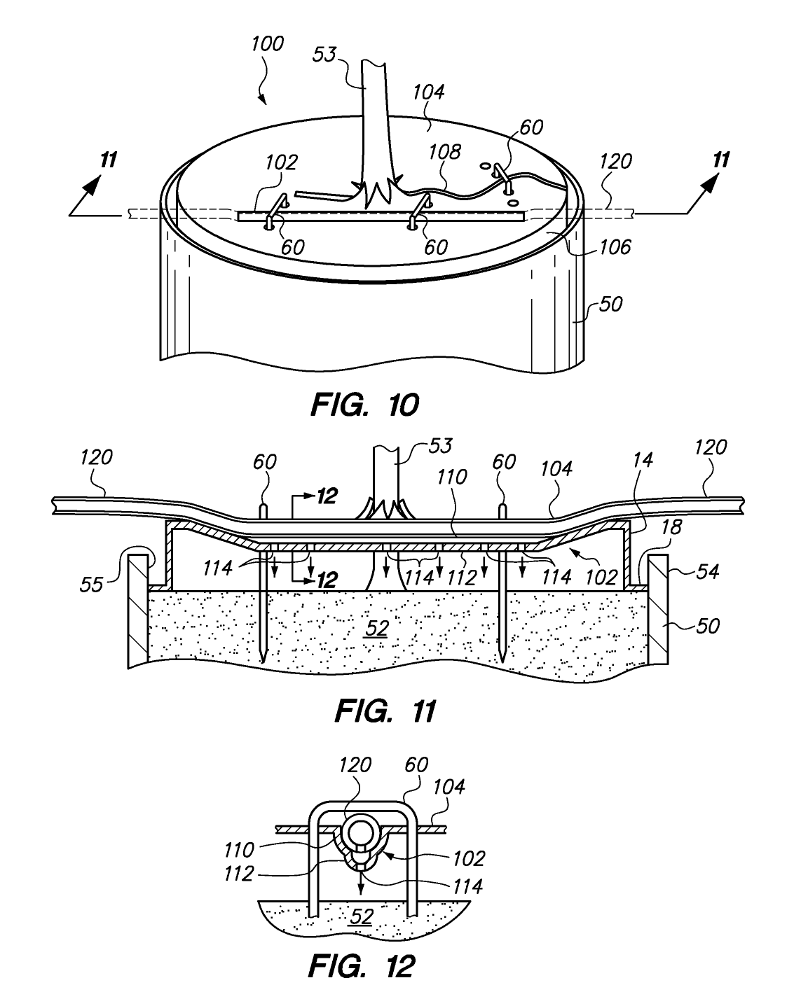

FIG. 10 is a perspective view of a second embodiment of a water retention device in a fully installed position within the plant container 50. As with the device 10 in FIG. 5, the resilient plate structure 100 has expanded radially outwardly because the resilient material of the plate structure 100 will tend to move back toward its relaxed condition (see FIG. 1). An optional landscaping staple 60 has been extended through a pair of holes 40, 42 that straddle the slot 20 to further secure the structure 100 and to specifically prevent an edge of the slot from catching wind.

The resilient plate structure 100 is used with a drip tube 120 rather than a spray stake. The drip tube 120 is received in a trough 102 that is formed in the cover 104 and extends along one side of the structure 100 to avoid interference with either the slot 108 or the opening that receives the stem 53 of the plant. The trough 102 is preferably linear, which facilitates a long drip tube extending along a row of containers 50 having similar resilient plate structures. Although the drip tube 120 could be secured in the trough 102 with built-in clips, a diameter providing a friction-fit, or plastic ties, a pair of landscaping staples 60 are shown in FIG. 10. As discussed further below, water from the drip tube 120 is supplied in the trough 102, which in turn allows the water to drip into the plant growth medium there below. Since water drips from the trough instead of being sprayed, there is no need for a plurality of ribs to be formed in the side wall 106.

FIG. 11 is a cross-sectional side view of the water retention device of FIG. 10 illustrating water distribution through the trough 102. The trough 102 is formed in the cover 104 and extends across a substantial portion of the diameter of the cover. In the embodiment shown, the trough 102 has a first upper portion 110 that receives the drip tube 120 and a second lower portion 112 that receives water from the drip tube 120. It is the lower portion 112 that remains open and facilitates the distribution of water along the length of the lower portion 112. Specifically, water in the lower portion 112 of the trough 102 flows laterally into communication with one or more of a plurality of holes 114. This lateral distribution of water prior to dripping into the plant growth medium 52 assists in the complete wetting of the medium 52.

As with the previous embodiments, the resilient plate structure 100 slows evaporation of water from the plant growth medium 52. Even water vapor that might pass through the plurality of holes 114 in the lower portion of the trough 102 is unable to freely escape the cover 104 since the drip tube 120 substantially fills the upper portion of the trough 102.

FIG. 12 is a cross-sectional view of the trough 102 formed in the cover 104 of the water retention device of FIG. 11. The upper portion 110 of the trough 102 receives the drip tube 120, which in this embodiment is secured in place by a landscaping staple 60. As shown, the upper portion 110 of the trough 102 has a diameter that is substantially the same as the diameter of the drip tube 120. The lower portion 112 of the trough 102 should extend downward and remain open. The lower portion may have any desired shape, such as a V-shaped groove, but is shown as having a radius that is smaller than that of the upper portion 110 and a lower central axis. In any of the foregoing configurations, water is supplied from the drip tube 120 into the lower portion 112 of the trough 102. Water collecting in the lower portion 112 may flow along the trough 102 and drip through one or more of the holes 114 into the growth medium 52.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A water retention device for use with a plant container, comprising:
a resilient plate structure forming a central cover, a sidewall extending from a perimeter of the central cover, and a slot extending through the sidewall and a portion of the central cover, wherein the sidewall engages an inner surface of the plant container and supports the central cover at a sufficient distance above a growth medium in the plant container to accommodate use of a spray nozzle under the central cover, wherein the resilient plate structure is manually configurable to open the slot for receiving a plant stem so that the plant stem extends through the central cover.

2. The water retention device of claim 1, wherein the sidewall has an inner surface forming a plurality of ribs.

3. The water retention device of claim 1, wherein the plurality of ribs on the inner surface of the sidewall form a continuous undulating surface.

4. The water retention device of claim 1, wherein the central cover has an inner surface forming a plurality of ribs.

5. The water retention device of claim 4, wherein the plurality of ribs are concentric.

6. The water retention device of claim 1, wherein the sidewall includes an outwardly-extending rim, and wherein at least a portion of the rim engages an inner surface of the plant container.

7. The water retention device of claim 6, wherein the rim forms a circular perimeter.

8. The water retention device of claim 1, wherein the resilient plate structure biases the slot toward a closed position, and wherein the slot enables a plant stem to extend through the cover with the slot in the closed position.

9. The water retention device of claim 1, wherein the slot enables a water supply tube to extend through the cover with the slot in the closed position.

10. The water retention device of claim 1, wherein the slot extends more than half way across a diameter of the resilient plate structure.

11. The water retention device of claim 1, further comprising:
a hole through the central cover to receive a stake to be secured in a growth medium within the plant container, wherein the stake includes a head larger than the hole so that the stake secures the central cover in an installed position.

12. The water retention device of claim 1, further comprising:
a first plurality of spaced apart holes through the central cover on a first side of the slot and a second plurality of spaced apart holes through the central cover on a second side of the slot, wherein the first plurality of spaced apart holes are aligned with the second plurality of spaced apart holes to receive a landscape staple there through.

13. A system for growing a plant, comprising:
a plant container including an inner surface having an inside diameter, wherein the inner surface extends above a growth medium within the plant container;
a resilient plate structure forming a central cover, a sidewall extending from a perimeter of the central cover, and a slot extending through the sidewall and a portion of the central cover, wherein the sidewall engages the inner surface of the plant container and supports the central cover at a spaced distance above the growth medium, wherein the resilient plate structure is manually configurable to open the slot for receiving a plant stem so that the plant stem extends through the central cover.

14. The system of claim 13, wherein the slot extends more than half way across a diameter of the resilient plate structure.

15. The system of claim 13, wherein the sidewall includes an outwardly-extending rim, and wherein at least a portion of the rim engages an inner surface of the plant container.

16. The system of claim 15, wherein the inner surface of the plant container includes one or more grooves for receiving at least a portion of the rim.

17. The system of claim 13, further comprising:
a spray nozzle disposed between the central cover and the growth medium within the plant container, wherein the spray nozzle is coupled to a water supply tube and directs water across the growth medium.

18. The system of claim 17, characterized in that the resilient plate structure substantially prevents water overspray.

19. The system of claim 17, wherein the central cover has a first notch along a first edge of the slot and second notch along a second edge of the slot, wherein the first and second notches are aligned for receiving the water supply tube therethrough even when the first and second edges of the slot are overlapped.

20. The system of claim 13, further comprising:
a trough formed in the central cover for receiving water from a drip tube, wherein the trough includes a plurality of holes for the passage of water from the trough to the growth medium within the plant container.

21. The system of claim 20, wherein trough has an upper portion sized to receive the drip tube and a lower portion sized to prevent entry of the drip tube and remain open to the flow of water, wherein the plurality of holes are formed in the lower portion of the trough.

22. The system of claim 21, wherein the trough extends in a straight line along one side of the central cover.

23. The system of claim 22, wherein the trough has first and second ends that have a tapered depth.

24. A method of installing a water retention cover about a stem of a plant within a plant container, comprising:
manually opening a slot formed in a sidewall and central cover of a resilient plate structure;
positioning the resilient plate structure so that the stem of the plant is received within the opened slot;
manually over-closing the slot to temporarily reduce the effective diameter of the resilient plate structure to less than the diameter of an inside surface of the plant container;
lowering the resilient plate structure inside the plant container; and
allowing the resilient plate structure to expand outwardly into engagement with the inside surface of the plant container.

25. The method of claim 24, wherein the slot extends more than half way across a diameter of the resilient plate structure.

26. The method of claim 24, wherein the sidewall includes an outwardly-extending rim, and wherein at least a portion of the rim engages an inner surface of the plant container.
